(19) United States
(12) Patent Application Publication
(10) Pub. No.: US 2025/0158409 A1
(43) Pub. Date: May 15, 2025

(54) VIRTUAL POWER PLANT

(71) Applicant: Cummins Inc., Columbus, IN (US)

(72) Inventors: John K. Heichelbech, Columbus, IN (US); John M. Monaghan, Columbus, IN (US)

(21) Appl. No.: 18/942,026

(22) Filed: Nov. 8, 2024

Related U.S. Application Data
(60) Provisional application No. 63/548,070, filed on Nov. 10, 2023.

(51) Int. Cl. H02J 3/32; B60L 55/00; G06Q 10/0631; G06Q 50/06; H02J 3/38

(52) U.S. Cl. CPC H02J 3/322; B60L 55/00; G06Q 10/0631; G06Q 50/06; H02J 3/381; H02J 2203/10; H02J 2300/10

(57) ABSTRACT

The present disclosure relates to the use of power-agnostic mobile vehicles, including internal combustion, hybrid, fuel cell, and battery electric vehicles, which can collectively transfer power back to the grid in ever larger and growing quantities of power. In other words, the present disclosure relates to the use of a network of vehicles to act as a grid.

### CROSS-REFERENCE TO RELATED PATENT APPLICATIONS

The present application claims the benefit of priority to U.S. Provisional Patent Application No. 63/548,070, filed Nov. 10, 2023, which is incorporated herein by reference in its entirety.

### FIELD OF THE DISCLOSURE

The present disclosure relates to virtual power plants and, more specifically, to systems in which energy-generating or energy-storing devices, such as vehicles, provide power to a grid system.

### BACKGROUND OF THE DISCLOSURE

An electric grid is conventionally used to power homes, businesses, vehicles, and other buildings and applications by providing electric power to said applications. Gensets may be used to provide power to a specific facility or microgrid in times of grid failure and other emergencies when power is unavailable, under available, or in higher demand than the grid can support. In other words, gensets may be used to provide power to an application when the grid is unable to provide the required or desired amount of power. Smaller scale devices, such as vehicles or home renewable energy resources, may also be used to provide power to the grid or to the applications mentioned above. Home photovoltaic systems typically generate less than 10 kW of power.

Maximum grid power is generally only required for short durations on a few days out of the year—for example, in times of severe temperatures. Generally speaking, maximum grid power may be utilized for only 1% of the year. However, the construction of additional power plants is required to provide that maximum energy to the grid, which comes with the associated costs of construction planning, construction, and staffing of the power plant, solely so the power plant can be used during 1% of the year to meet maximum demand.

Furthermore, once need for more power is identified, it can up to several years to construct a power plant to a state ready to provide power, at which point grid users have been using suboptimal grid power. Environmentally friendly options such as wind, solar, and battery storage may be added to the grid, but the permitting process typically involve several years of delay and waiting in-queue. Network transmission lines and equipment lines required to convey electrical power from large powerplants—including both combustion sources and clean sources such as wind and solar farms—to the point of use also require significant investments of time and resources.

### SUMMARY

The present disclosure relates to the use of power-agnostic mobile vehicles, including internal combustion, hybrid, fuel cell, and battery electric vehicles, which can collectively transfer power back to the grid in ever larger and growing quantities of power. In other words, the present disclosure relates to the use of a network of vehicles to act as a grid.

In an initial aspect of the disclosure, a power-generating apparatus is disclosed. The apparatus includes a charge controller and an inverter. The inverter is configured to receive a signal transmitted by the charge controller; convert DC power to AC power; and export 5-500 kW of AC power from the power-generating apparatus to a grid electrically coupled to the power-generating apparatus.

In another aspect of the disclosure, a system for aggregation and exportation of power to the grid is disclosed. The system includes a controller configured to monitor a grid stability of a grid and a cost of a unit of energy; monitor a status of a plurality of nodes within a fleet, wherein the fleet comprises a combination of mobile and stationary resources; and selectively receive and execute remote instructions from a user for transferring energy from at least one node of the plurality of nodes within the fleet to a grid.

In yet another aspect of the disclosure, a method of using an interconnected system with a grid is disclosed. The method includes: monitoring a connection status of one or more nodes within an interconnected system with a processor communicatively coupled to the one or more nodes; detecting a triggering event with the processor; receiving, with a charge controller of at least one node of the one or more nodes, a signal generated by the processor instructing the charge controller of the at least one node of the one or more nodes to transfer power form the at least one node of the one or more nodes to the grid; and transferring power from the at least one node to the grid. The triggering event may be at least one of: an emergency event, an insufficient grid power event, or an event in which a price of an energy unit meets or crosses a predetermined threshold.

In various aspects of the disclosure, the inverter may be a bidirectional inverter configured to receive AC power from a charge system connected to the power-generating apparatus and convert received AC power to DC power.

In various aspects of the disclosure, the controller may be further configured to manage and monitor energy and value generation to the grid.

In various aspects of the disclosure, the system may further include a bidirectional AC-DC-AC digital switching device. The bidirectional AC-DC-AC digital switching device may be configured to: convert DC power to AC power during energy transfer form at least one node of the plurality of nodes within the fleet; monitor AC power voltage, frequency, and phase angle of the grid; monitor power transferred from at least one vehicle of the plurality of vehicles within the fleet for compatibility with the AC power voltage, frequency, and phase angle of the grid; and record to a memory the grid power quality and timing to facilitate generation of a compatible waveform. The bidirectional AC-DC-AC digital switching device may be configured to facilitate charging of DC batteries of at least one node of the plurality of nodes within the fleet.

In various aspects of the disclosure, the system may further include a communication system communicatively coupled with the controller and each node of the plurality of nodes within the fleet.

In various aspects of the disclosure, the nodes may include internal combustion generating units, hybrid combustion and electric units, battery electric units, or a combination thereof.

In various aspects of the disclosure, the interconnected system may be a closed system governed by a single entity.

In various aspects of the disclosure, the grid may be a microgrid configured to selectively provide power to a limited set of at least one of a consumer, a site, and an application.

In various aspects of the disclosure, the one or more nodes may include at least one internal-combustion engine.

In various aspects of the disclosure, the method may further include receiving, with the charge controller of the at least one node of the one or more nodes, a signal generated by the processor instructing an increase in at least one of an amount and a rate of power transferred to the grid from the at least one node.

In various aspects of the disclosure, the method may further include receiving, with a second charge controller of an additional node of the one or more nodes of the interconnected system, a signal generated by the processor instructing the second charge controller of the additional node of the one or more nodes to transfer power from the additional node of the one or more nodes to the grid.

In various aspects of the disclosure, the method may further include receiving, with the charge controller of the at least one node of the one or more nodes, a signal generated by the processor instructing decrease in at least one of an amount and a rate of power transferred to the grid from the at least one node of the one or more nodes to the grid. The signal may instruct cessation of power transfer from the at least one node of the one or more nodes to the grid.

In various aspects of the disclosure, the step of receiving the signal instructing the charge controller of the at least one node of the one or more nodes to transfer power from the at least one node of the one or more nodes to the grid may happen automatically upon detection of the triggering event.

In various aspects of the disclosure, the step of monitoring the connection status of the one or more nodes may include receiving, with the processor, a signal from a telemetry unit of a respective node of the one or more nodes, wherein the telemetry unit may be triggered to transmit the signal to the processor by: receiving, with the telemetry unit, a signal from a respective charge controller of the respective node, the signal being transmitted from the respective charge controller upon connection of at least one of a charge system and a charger to a receiver of the respective node.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a schematic block diagram of a vehicle system;

FIG. 2 is a schematic system for a system of interconnected nodes, which may include, for example, the vehicle of FIG. 1;

FIG. 3 is a schematic system illustrating a node arrangement of the system of FIG. 2, including a node, a charging system, and a communication system;

FIG. 4 illustrates a flowchart of an operation of the system of interconnected nodes for providing power from the interconnected nodes back to a grid; and

FIG. 5 illustrates a flowchart of an operation of an entity-limited interconnected system for providing power from the interconnected nodes back to the grid.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Virtual power plants may rely on classes of stationary devices that are or can be connected to the grid or a microgrid, such as a powerwall or battery electric vehicles plugged into a charging station. Stationary power may also be aggregated into virtual power plants, which is then provided back to the grid in an emergency and/or for revenue.

Vehicles with internal combustion engines may include aftertreatment emissions systems that are generally preheated for use. In such applications, electric heat may be provided to the emissions system to preheat the emission control system. However, such preheating is only conducted when the emission control system is below a certain predetermined temperature threshold. When conditions are such that the emission control system is already above the predetermined temperature threshold before start-up/key-on of the corresponding vehicle, the electric heat otherwise reserved for such preheating maybe available to be provided back to the grid in the form of electric power. The transfer of this power for electric heat back to the grid may also occur in an emergency, e.g., grid failure, when emissions are below the required threshold so that emission control system usage is not immediately necessary, or when a certain price point is reached so that the benefit of providing the power to the grid outweighs the cost. This transfer of electric heat may include about 10 kW of electrical power, in which case the provided power provided back to the grid exceeds most residential solar array's peak or continuous power export ability. Some applications may provide less or more power, e.g., about 5 kW, about 15 kW, about 20 kW, and about 25 kW. Use of internal combustion systems within the interconnected system described herein provides an added benefit, as electricity can be derived from fuel while mitigating or eliminating degradation to electric vehicle batteries.

Hybrid vehicles may be capable of providing a greater amount of instantaneous electric power than an internal combustion engine vehicle because hybrid vehicles have a greater reserve of electric power. For example, hybrid vehicles may be capable of providing about 30 kW, about 40 kW, about 50 kW, about 60 kW, about 70 kW, about 75 kW, about 80 kW, about 85 kW, about 90 kW, about 95 kW, about 100 kW, about 110 kW, and about 125 kW. Similarly, battery electric vehicles may be capable of providing a greater amount of instantaneous electric power than an internal combustion engine vehicle or a hybrid vehicle due to the increased electric power reserve. For example, battery electric vehicles may be capable of providing about 115 kW, about 125 kW, about 135 kW, about 140 kW, about 145 kW, about 150 kW, about 155 kW, about 160 kW, about 170 kW, and about 180 kW. Future battery electric vehicles may be able to provide even a greater amount of energy, up to and including 500 kW or greater.

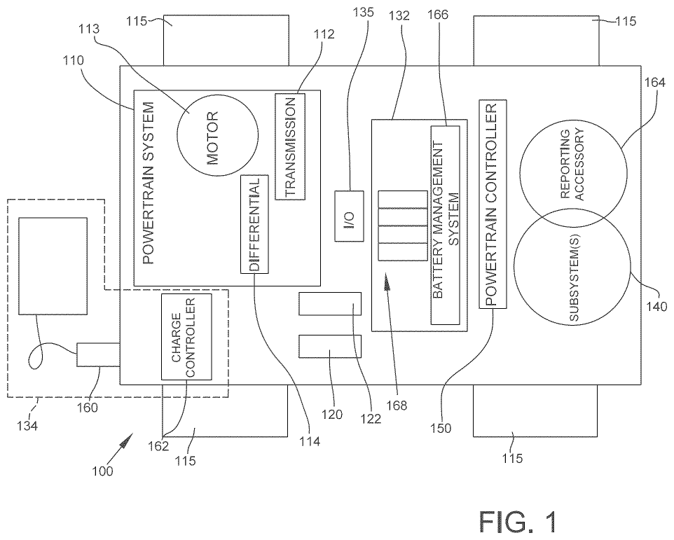

Referring initially to FIG. 1, a schematic diagram of a battery electric vehicle 100 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 100 may be operable in at least one of a reverse direction (e.g., a backward direction relative to a front end of battery electric vehicle 100) and a non-reverse direction (e.g., a forward direction, angular direction, etc., relative to the front end of battery electric vehicle 100). Battery electric vehicle 100 may be an on-road or off-road vehicle including, but not limited to, cars, trucks, ships, boats, vans, airplanes, spacecraft, or any other type of vehicle.

Battery electric vehicle 100 comprises a powertrain controller 150 communicably and operatively coupled to a powertrain system 110, a brake mechanism 120, an accelerator pedal 122, one or more sensors, an operator input/output (I/O) device 135, and one or more additional vehicle subsystems 140. Battery electric vehicle 100 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 110 facilitates power transfer from a battery 132 and/or a motor 113 to power battery electric vehicle 100. In an exemplary embodiment, powertrain system 110 includes motor 113 operably coupled to battery 132 and charge system 134, where motor 113 transfers power to a final drive (e.g., wheels 115) to propel battery electric vehicle 100. As depicted, powertrain system 110 may include other various components, such as a transmission 112 and/or differential 114, where differential 114 transfers power output from transmission 112 to final drive 115 to propel battery electric vehicle 100. Powertrain controller 150 of battery electric vehicle 100 provides electricity to motor 113 (e.g., an electric motor) in response to various inputs received by powertrain controller 150, for example, from accelerator pedal 122, sensors, vehicle subsystems 140, charge system 134 (e.g., a battery charging system, rechargeable battery, etc.). In some embodiments, electricity provided to power motor 113 may be provided by an onboard gasoline-engine generator, a hydrogen fuel cell, etc.

In some embodiments, battery electric vehicle 100 may include transmission 112. Transmission 112 may be structured as any type of transmission compatible with battery electric vehicle 100, including a continuous variable transmission, a manual transmission, an automatic transmission, an automatic-manual transmission, or a dual clutch transmission, for example. Accordingly, as transmissions vary from geared to continuous configurations, transmission 112 may include a variety of settings (e.g., gears, for a geared transmission) that affect different output speeds based on an engine speed or motor speed. Like transmission 112, motor 113, differential 114, and final drive 115 may be structured in any configuration compatible with battery electric vehicle 100. In some embodiments, transmission 112, is omitted and motor 113 is directly coupled to differential 114. In other embodiments, motor 113 is directly coupled to final drive 115 as a direct drive application. In some examples, battery electric vehicle may comprise multiple instances of motor 113, for example, one instance for each driven wheel, one instance per driven axle, or other compatible arrangements.

Brake mechanism 120 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 100). Generally, brake mechanism 120 is configured to receive an indication of a desired change in the vehicle speed. In some embodiments, brake mechanism 120 comprises a brake pedal operable between a released state and an applied state by an operator of battery electric vehicle 100. The brake pedal may be configured as a pressure-based system responsive to applied pressure or a travel-based system responsive to a travel distance of the pedal, where a force applied to brake mechanism 120 is proportional to the pressure and/or travel distance. In some embodiments, all or a portion of brake mechanism 120 is incorporated into motor 113, for example, as a regenerative brake mechanism.

Generally, the released state of brake mechanism 120 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 122 in a one-pedal driving configuration. In some examples, the applied state of brake mechanism 120 may correspond to the brake pedal being pressed with a force that meets or exceeds the minimum actuation force. In other examples, the applied state of brake mechanism 120 corresponds to the brake pedal being pressed so that the travel distance of the brake pedal meets or exceeds a minimum travel distance. Generally, the minimum actuation force and/or minimum travel distance help to prevent accidental actuation of brake mechanism 120. Different levels of the minimum actuation force and/or minimum travel distance may be used for different implementations of brake mechanism 120, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 100 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 122 may be structured as any type of torque and/or speed request device included with a system (e.g., a floor-based pedal, an acceleration lever, paddle or joystick, etc.). Sensors associated with accelerator pedal 122 and/or brake mechanism 120 may include a vehicle speed sensor that provides a vehicle speed signal corresponding to a vehicle speed of battery electric vehicle 100, an accelerator pedal position sensor that acquires data indicative of a depression amount of the pedal (e.g., a potentiometer), a brake mechanism sensor that acquires data indicative of a depression amount (pressure or travel) of brake mechanism 120, a coolant temperature sensor, a pressure sensor, an ambient air temperature, or other suitable sensors.

Battery electric vehicle 100 may include operator I/O device 135. Operator I/O device 135 may enable an operator of the vehicle to communicate with battery electric vehicle 100 and/or powertrain controller 150. Analogously, operator I/O device 135 enables battery electric vehicle 100 and/or powertrain controller 150 to communicate with the operator. For example, operator I/O device 135 may include, but is not limited to, an interactive display (e.g., a touchscreen) having one or more buttons, input devices, haptic feedback devices, an accelerator pedal, a brake pedal, a shifter or other interface for transmission 112, a cruise control input setting, a navigation input setting, or other settings or adjustments available to the operator. Via operator I/O device 135, powertrain controller 150 can also provide commands, instructions, and/or information to the operator or a passenger.

Battery electric vehicle 100 includes one or more vehicle subsystems 140, which may generally include one or more sensors (e.g., a speed sensor, ambient pressure sensor, temperature sensor, etc.), as well as any other subsystem that may be included with a vehicle. Vehicle subsystems 140 may also include torque sensors for one or more of motor 113, transmission 112, differential 114, and/or final drive 115. Other vehicle subsystems 140 may include a steering subsystem for managing steering functions, such as electrical power steering, and output information such as wheel position and fault codes corresponding to steering battery electric vehicle 100; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Battery electric vehicle 100 may include further sensors other than those otherwise discussed herein, such as cameras, LIDAR, and/or RADAR, temperature sensors, smoke detectors, virtual sensors, among other potential sensors.

Powertrain controller 150 may be communicably and operatively coupled to powertrain system 110, brake mechanism 120, accelerator pedal 122, operator I/O device 135, and one or more vehicle subsystems 140. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 150 is structured to receive data (e.g., instructions, commands, signals, values, etc.) from one or more of the components of battery electric vehicle 100 as described herein via the communicable coupling of powertrain controller 150 to the systems and components of battery electric vehicle 100. In some embodiments, an additional or alternative controller may be used for receiving data from certain systems or components.

In vehicles including charge system 134, such as a plug-in charging system, battery electric vehicle 100 may powertrain controller 150 may control charging of battery 132 when a charger 160 of charge system 134 is connected to battery electric vehicle 100. A charge controller 162 establishes communications between powertrain controller 150 and charger 160. Charge controller 162 may receive a charge command from powertrain controller 150 and charger 160. Charge controller 162 may monitor sensor signals and perform safety and performance checks and determine faults based thereon. For example, charge controller 162 may determine a fault if charging has started but a physical connection between charger 160 and battery electric vehicle 100 fails to be detected or is detected to be outside safe boundaries. In other words, charge controller 162 may function as a communication interface between charger 160 and powertrain controller 150.

Powertrain controller 150 may be communicably coupled with charge controller 162, battery 132 and a reporting accessory 164 so that digital data may be transferred between components. Reporting accessory 164 may be include a vehicle subsystem 140 or another vehicle component. A CAN bus may be implemented to provide communications. In some embodiments, a first CAN bus may be implemented to provide communications between a first plurality of components while a second CAN bus may be implemented to provide communications between a second plurality of components. Any series or parallel communication scheme and protocol known in the arm may be implemented to provide communication.

Reporting accessory 164 may be operable to communicate information to powertrain controller 150. Such information may include identification, current demand, high or low voltage power draw, and other information required for operation of battery electric vehicle 100. Identification information may include a maximum current capacity of reporting accessory 164, for example. The current demand may be dynamic, such that the current demanded by reporting accessory 164 varies. Reporting accessory 164 may include an air-conditioning system, for example, and the current demand may vary based on a measured actual temperature of an interior of battery electric battery 100 compared to a target temperature. By reporting current demand to powertrain controller 150, reporting accessory 164 enables powertrain controller 150 to more accurately determine the target current to generate the charge command to charge controller 162, and, thereby, to charger 160. Comparatively, when the load of a non-reporting accessory is dynamic and unknown, charger 160 may underdeliver current to battery 132 via charge controller 162, extending charging time. The charge command may also take into account the charger's capability to deliver current and indicates to charger 160 via charge controller 162 the level of current to output to battery electric vehicle 100, which is ideally sufficient to optimally charge battery 132 and also power the accessories.

Battery 132 may include one or more battery packs including a battery management unit 166 and battery modules 168. FIG. 1 is not determinative of the number of battery modules within a battery pack or the number of battery packs within battery 132. Battery 132 may include a greater number of battery packs and/or a greater or lesser number of battery modules.

Temperature, voltage, and other sensors may be provided to enable battery management unit 166 to manage the charging and discharging of battery modules 168 without exceeding their limits, to detect and manage faults, and to perform other known functions. Battery management unit 166 may transmit data to powertrain controller 150 related to information about battery 132, including the battery charge power limit, temperature, faults, etc. Battery 132 may include a current sensor to provide a measured current value to battery management unit 166, which may be used to affect the charge command provided to charge controller 162 and charger 160. The current sensor may be located elsewhere. Multiple current sensors may be used, each current sensor associated with a battery module of battery 132, where the sum of the measured currents being the measured current of battery 132.

Powertrain controller 150 may include a charge logic operable to determine a command for charge controller 162 and charger 160 to supply a target current to battery 132. The charge logic may also be integrated with a controller of battery management unit 166 or provided in a standalone controller communicatively coupled to powertrain controller 150. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers”. Therefore, in accordance with the disclosure, various logic may be implemented in any appropriate fashion. A non-transitory machine-readable medium comprising logic can additionally be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid expensive grid peak load periods where possible. The charging management system may also assign time slots for charging to each vehicle and monitor the progress of charging of each vehicle. The charging management system may receive from each vehicle an estimated time to full charge. In other embodiments, the vehicle may provide the relevant data to the charging management system, which may then estimate the time to full charge within its control logic.

Although FIG. 1 is described as illustrating a battery electric vehicle, the disclosure provided herein may also apply to vehicles having other powertrains, such as, for example, a plug-in hybrid vehicle. In such embodiments, the vehicle optionally includes an engine which may be structured as an internal combustion engine that receives a chemical energy input (e.g., a fuel such as natural gas, gasoline, ethanol, or diesel) from a fuel delivery system, and combusts the fuel to generate mechanical energy, in the form of a rotating crankshaft. In such an embodiment, transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by differential, which provides the rotation energy from the drive shaft to final drive, which then propels or moves the vehicle. The disclosure provided herein also refers to internal combustion vehicles, which use internal combustion engines such as those discussed above for powering of the vehicle.

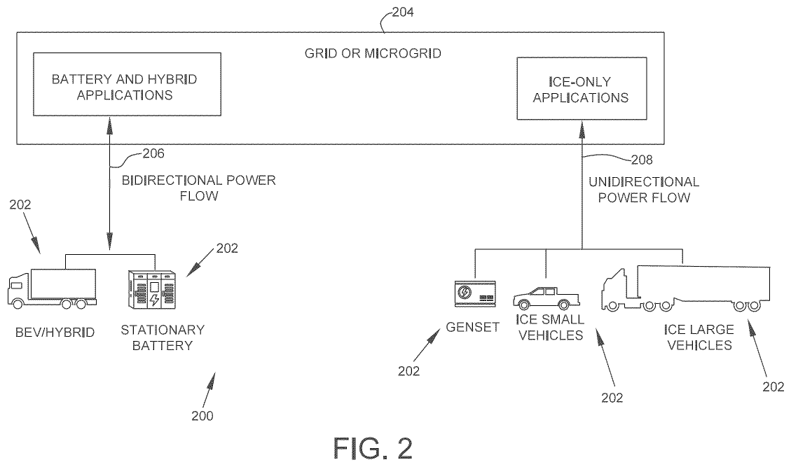

Referring to FIG. 2, a system 200 of interconnected vehicles and/or stationary power systems, hereinafter referred to as “nodes” 202 connected to the grid is illustrated. As shown, nodes 202 may include any or all of battery electric vehicles, hybrid vehicles, stationary batteries, gensets, small vehicles including internal combustion engines, and large vehicles including internal combustion engines. Each node 202 of system 200 is connected to a microgrid or grid 204. Battery and hybrid applications, such as battery electric vehicles, hybrid vehicles, and stationary batteries, may be connected to grid 204 via a bidirectional power flow 206, i.e., wherein power is configured to be transferred from grid 204 to node 202 and power is configured to be transferred from node 202 to grid 204. Internal combustion applications, such as gensets, small vehicles including internal combustion engines, and large vehicles including internal combustion engines, may be connected to grid 204 via a unidirectional power flow 208, wherein power is configured to be transferred from node 202 to grid 204 only.

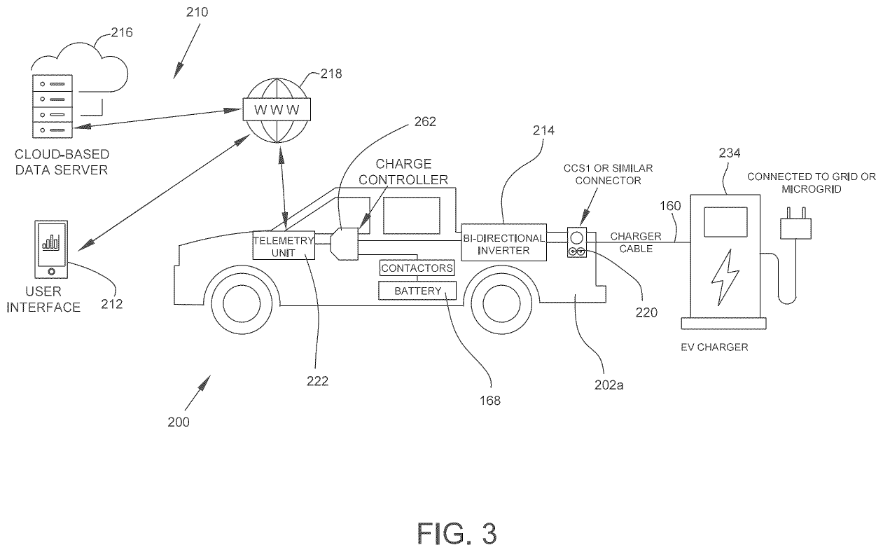

Referring additionally to FIG. 3, the connective system of a node 202a to grid 204 (FIG. 2) and communication system 210 is illustrated. Node 202a as described herein may be consistent with a battery electric vehicle and/or a hybrid vehicle unless otherwise noted. Node 202a as described herein may also apply to a stationary power system such as a stationary battery. Node 202a may include a bi-directional DC-AC inverter 214 capable of both battery charging and exportation to grid 204, charge controller 262 configured to synchronize each node 202a with grid 204, and a user interface 212 as part of communication system 210 to command start and stop of power supply to grid 204 installed in or otherwise communicatively coupled with each vehicle (e.g, via a personal user interface that may be used remotely from the vehicle). An internal combustion vehicle and/or stationary power system may also include an inverter for exportation of power to grid 204 as disclosed further herein, a charge controller for synchronization of the vehicle with the grid, and a user interface as part of communication system 210 as described above.

Node 202a may be configured to connect with a charge system 134 and corresponding charger 160 for vehicle-to-grid transfer of power. That is, even in internal combustion vehicles and/or stationary power systems that may otherwise not use a charger, a receiver similar to a receiver 220 of node 202a may be installed on each internal combustion vehicle and/or stationary power system, where the receiver is configured to receive the charger to allow for transfer of power from the node to the grid and/or from the grid to the node in appropriate instances. Bidirectional DC-AC inverter 214 or other inverter discussed above may correspond with the individual node's electric power capabilities. That is, the inverter, bidirectional or unidirectional, installed on an internal combustion vehicle and/or stationary power system may be configured to export from about 5-25 kW AC power to the grid, while the bidirectional DC-AC inverter installed on a hybrid vehicle may be configured to export from about 30-125 kW AC power to the grid, and while the bidirectional DC-AC inverter installed on a battery electric vehicle may be configured to export from about 115-500 kW or more AC power to the grid. For example, each vehicle may include a bidirectional DC-AC inverter capable of transferring at least the same amount of electric power to the grid that the vehicle is capable of holding in reserve.

The DC-AC inverter may be a bidirectional AC-DC-AC digital switching device which supports charging of batteries 168 in appropriate nodes (e.g., node 202a) and conversion of DC power to AC power to transfer said power to grid 204. The bidirectional AC-DC-AC digital switching device may further monitor the grid AC power voltage, frequency, and phase angle (e.g., power quality) to ensure that power transferred from the node to the grid is compatible and in-synch with the grid wave form. The AC-DC-AC digital switching device may further record to memory the grid power quality and timing in order to generate a compatible waveform even if the grid is down, i.e., grid-forming.

Charge controller 262 may be configured for synchronization of each node 202 with grid 204 and may further be configured for permanent synchronization to grid 204 in accordance with grid 204 to which node 202 may be connected. For example, charge controller 262 may synchronize to the grid at 50 Hz or 60 Hz and provide voltage and current waveforms at a unity PF 1.0, even when grid 204 is intermittent or down (e.g., grid-forming).

Each node, including node 202a and nodes having an internal combustion engine may be in communication with an aggregation application coupled to or integrated with user interface 212 that monitors vehicle status, real-time power pricing, and includes look-ahead capability for determining the power needs of the corresponding node. User interface 212 may include a vehicle touchscreen, smart phone, personal smart device, or another user interface—which allows for user control and/or an opt-out function of vehicle-to-grid power transfer. Communication system 210 may further track, save, and display power generation and transfer history. Communication system 210 may provide all functions of communication, control, and AC/DC conversion within user interface 212 (e.g., a handheld device), or may do so via user interface 212, a data server 216, Internet connectivity 218, or any combination thereof. Vehicle 202a and internal combustion vehicles and/or stationary systems may communicate with communication system 210 via a telemetry unit 222 installed on the corresponding vehicle.

In an exemplary embodiment, data server 216 may be configured to store the aggregation application as discussed herein. In other words, data server 216 may serve as a processor configured to manage grid demand and response, receive input from user interface 212, and communicate with the corresponding node 202 via telemetry unit 222 over a communication network, such as an Internet connection 218. Telemetry unit 222 may be configured to aggregate relevant information from node 202 and transmit the information to data server 216 for execution of the method as described further herein.

The system may further include a virtual market application for excess power, as well as encryption and security for protection of data. The virtual market application is established by creating an aggregated virtual power plant of vehicle applications via the communications systems and corresponding vehicles within the interconnected system. By aggregating all of the vehicles and their corresponding communications systems, the provided electric power can generate revenue optimized for highest dollar value per kW/hr; total or local emissions of the interconnected vehicle fleet; and/or maximum power in the event of a grid emergency. The system may further be optimized as a corporate, state, or national level to monetize carbon credits by balancing power demand with total carbon emissions such that maximum customer value can be generated from both power sales and carbon avoidance.

The aggregation application may be installed on a hardware controller, e.g., a processor configured for remote transmission and communication. The aggregation application may monitor grid stability and energy costs; monitor status of each node within the interconnected system (e.g., a fleet); allow users to sell generated power to the grid via the corresponding communication system for the node; manage and monitor energy and value generation to the grid; and command response of the nodes remotely in response to user command. The aggregation application is in contact with each communication system of each vehicle of the interconnected system so that the vehicles are interconnected via said communication systems and the aggregation application.

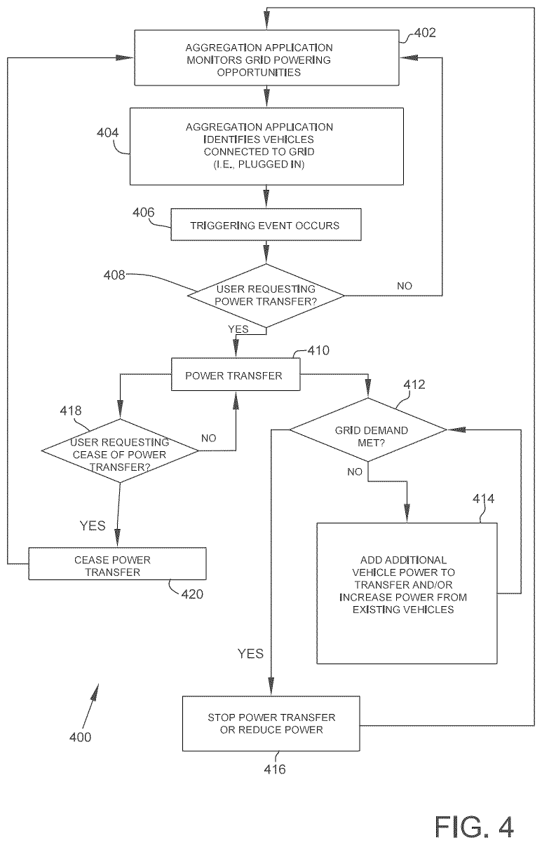

Referring to FIG. 4 in view of FIGS. 2-3, a method 400 of using interconnected system 200 described above is illustrated. The aggregation application, e.g., via data server 216 or, in some embodiments, user interface 212, continuously monitors grid powering opportunities, as shown at box 402, and nodes 202 within the interconnected system (e.g., a fleet) that are connected to grid 204 (e.g., via charge system 134 and/or charger 160), as shown at box 404. For example, when charge system 134 and/or charger 160 are connected to node 202, charge controller 162 receives a signal from receiver 220 and transmits a signal to telemetry unit 222, which in turn transmits a signal to the aggregation application via data server 216 or user interface 212 and, in some embodiments, Internet connectivity 218.

When a triggering event occurs, as shown at box 406, such as an emergency event, an insufficient grid power event, or when a price of energy units meets or crosses a predetermined threshold, the aggregation application (e.g., data server 216 and/or user interface 212) transmits a signal and/or notification to a user via user interface 212 of each connected node 202 within system of interconnected nodes 200. Each user may choose whether or not to request a power transfer from corresponding node 202 to grid 204, as shown at box 408. In some embodiments, the user may choose to opt into the power transfer at the time of reception of the signal and/or notification to user interface 212. In other embodiments, the user may configure user interface 212 to automatically transmit an acceptance signal to the aggregation application (e.g., blanket opt-in). In yet other embodiments, the user may configure user interface 212 to automatically transmit a rejection signal or to fail to transmit any signal to the aggregation application (e.g., blanket opt-out).

If the user chooses to accept the power transfer via user interface 212, user interface 212 and/or data server 216 transmits a signal to corresponding node 202 via, for example, Internet connectivity 218, telemetry unit 222, and/or charge controller 262 to instruct charge controller 262 to push power back to grid 204, as shown at box 410. The aggregation application (e.g., via data server 216 and/or user interface 212) continues to monitor the grid demand, as shown at box 412.

If the grid demand is not met at box 412 during or after transfer of power from node 202 to grid 204, the aggregation application may add additional nodes 202 of the interconnected system 200 as said nodes 202 become available (e.g., as they are connected to the grid and the user chooses to transfer power), as discussed above. Additionally, or alternatively, the aggregation application may increase the power transfer from the nodes that are already connected to grid 204, as shown at box 414. For example, at box 410, in some embodiments, the aggregation application may transmit a signal to charge controller 262 causing node 202 to push a specific amount of power to grid 204. In such embodiments, the aggregation application may transmit a signal to charge controller 262 causing node 202 to push a greater amount of power to grid 204 at box 414 relative to the amount of power pushed to grid 204 from node 202 at box 410.

If the grid demand is met at box 412, the aggregation application may transmit a signal to charge controller 262 causing a decrease in power transfer or ceasing of the power transfer altogether, as shown at box 416. If, at any time, the user requests cessation of the power transfer via, e.g., user interface 212, as shown at box 418, the aggregation application transmits a signal to charge controller 262 to cease the power transfer, as shown at box 420.

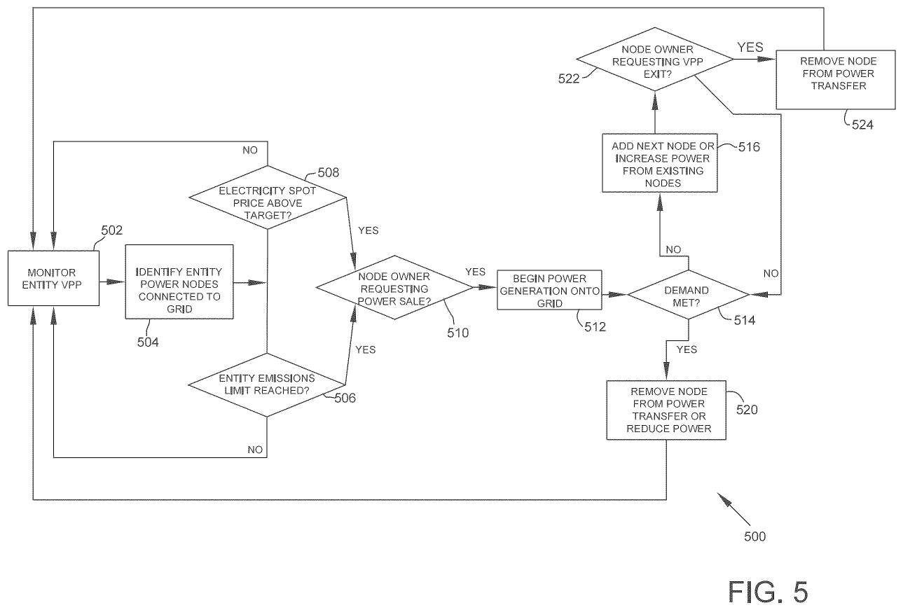

Now referring to FIG. 5 in view of FIGS. 2-3, a method 500 of managing a virtual power point in view of carbon emissions and/or power cost is disclosed. The aggregation application, e.g., a processor, continuously monitors an entity-limited interconnected system (e.g., similar to interconnected system 200) at box 502, including nodes 202, within the entity-limited interconnected system and which of said nodes 202 are actively connected to the system, or grid 204 (e.g., via charge system 134 and/or charger 160), as shown at box 504. The processor including aggregation application may include data server 216 or, in some embodiments, user interface 212 or a combination thereof. When charge system 134 and/or charger 160 are connected to node 202, charge controller 162 receives a signal from receiver 220 and transmits a signal to telemetry unit 222, which in turn transmits a signal to the aggregation application via data server 216 or user interface 212 and, in some embodiments, Internet connectivity 218. As described further herein, an “entity-limited interconnected system” refers to a fleet or fleets which comprises a system of nodes identified in a common group. The aggregation application continues to monitor the entity-limited interconnected system even as method 500 continues through the remaining steps.

At box 506, the aggregation application (e.g., processor) determines whether the predetermined threshold for emissions has been reached. In other words, a predetermined threshold may be set for emissions released by a collective fleet of nodes for the corresponding entity. If the predetermined threshold for emissions is not met, the determination at box 506 is false, and the aggregation application continues to monitor the entity-limited interconnected system at box 502. If the predetermined threshold for emissions is met, the determination at box 506 is true, and method 500 may continue to box 510 as described further herein.

The predetermined threshold for emissions at box 506 may be set according to certain limits according to a desire of the user and/or for compliance with relevant regulations. In some embodiments, the predetermined threshold for emissions may be set and/or altered according to an optimization feature of the relevant node(s) and/or collective fleet of nodes. The optimization feature may be an artificial intelligence optimization feature, for example. In some embodiments, the optimization feature may be related to energy efficiency, levelized cost of energy (LCOE), etc., in additional to or alternatively to emissions.

Optimization, compliance, and/or limit setting relative to box 506 may be tailored to and/or altered for a specific region. For example, certain city ordinances may extremely limit emissions so that only non-combustion energy can be generated. In other examples, the node(s) may be located within a zero-emission zone outside of a city. In other examples, on the same grid but outside of the urban-exclusion zone and/or zero-emission zone, other hybrid or combustion-only resources may be located in an area so that they are still available to generate and return power to the grid, as the emission limit in said location has not been exceeded. Other combinations of node location(s) and relevant emissions limits or optimization levels—whether on the same grid or varying grids—is within the scope of the disclosure.

Simultaneously, at box 508, the aggregation application determines whether the predetermined price threshold has been reached. In other words, a predetermined price threshold may be set per unit of electricity sold to the grid. If the predetermined price threshold is met, then the determination at box 508 is true, and method 500 may continue to box 510 as described further herein. If the predetermined price threshold is not met, then the determination at box 508 is false. If the determination at box 508 is false, that is, if the predetermined price threshold has not been met, the aggregation application continues to monitor the entity-limited interconnected system at box 502.

If the determination at either or both of box 506 and box 508 are false, the aggregation application may continue to monitor the entity limited interconnected system at box 502 without consideration of box 510. If the determination at both box 506 and box 508 is true, method 500 continues to box 510. In some embodiments, if the determination at one of box 506 and box 508 is true but the determination at the other of box 506 and box 508 is false, method 500 may continue to box 510. At box 510, the aggregation application determines whether a user of at least one node within the entity-limited interconnected system has opted into a power transfer from node 202 to grid 204. For example, at box 510, the aggregation application transmits a signal and/or notification to the user via user interface 212. In some embodiments, the user may choose to opt into the power transfer at the time of reception of the signal and/or notification to user interface 212. In other embodiments, the user may configure user interface 212 to automatically transmit an acceptance signal to the aggregation application (e.g., blanket opt-in). In yet other embodiments, the user may configure user interface 212 to automatically transmit a rejection signal or to fail to transmit any signal to the aggregation application (e.g., blanket opt-out).

If the user chooses to accept the power transfer via user interface 212, the aggregation application (e.g., via user interface 212 and/or data server 216) transmits a signal to corresponding node 202 via, for example, Internet connectivity 218, telemetry unit 222, and/or charge controller 262 to instruct charge controller 262 to push power back to grid 204, as shown at box 512. The aggregation application (e.g., via data server 216 and/or user interface 212) continues to monitor the grid demand, as shown at box 514.

If the grid demand is not met during or after transfer of power from node 202 to grid 204, the aggregation application may add additional nodes 202 of the interconnected system 200 as said nodes 202 become available (e.g., as they are connected to the grid and the user chooses to transfer power), as discussed above as shown at box 516. Additionally, or alternatively, the aggregation application may increase the power transfer from the nodes that are already connected to grid 204, as shown at box 516. For example, at box 512, in some embodiments, the aggregation application may transmit a signal to charge controller 262 causing node 202 to push a specific amount of power to grid 204. In such embodiments, the aggregation application may transmit a signal to charge controller 262 causing node 202 to push a greater amount of power to grid 204 at box 516 relative to the amount of power pushed to grid 204 from node 202 at box 512.

If the grid demand is met at box 514, the aggregation application may transmit a signal to charge controller 262 causing a decrease in power transfer or ceasing of the power transfer altogether, as shown at box 520. If, at any time, the user requests cessation of the power transfer via, e.g., user interface 212, as shown at box 522, the aggregation application transmits a signal to charge controller 262 to cease the power transfer, as shown at box 524.

The interconnected system functions to create a virtual, on-demand, and emergency-response power plant which can be either grid-supporting or grid-forming. The interconnected system may support an active grid to maintain voltage and current to meet demand and/or maximize revenue. The interconnected system may additionally or alternately establish a microgrid capable of providing power to limited set of consumers, sites, and/or applications. Because the power plant resulting from the interconnected system is on-demand and near-instantaneous, it can be used for peak shaving, or for supporting maximum grid usage, which in turn allows for mitigation or avoidance of cost and/or lead time of building new power plants (i.e., peak power plants) or provide needed power in cases of energy shortages. Furthermore, the interconnected system monitors the voltage, frequency, and quality of energy to ensure constant synchronization with the grid, mitigating errors that may result from unsynchronized energy sources. This interconnected system may also be deployed to correct problems with grid power generation such as voltage droop or phase angle lag that result from insufficient spinning resources (e.g. insufficient inertia from traditional combustion power plants).

The terms “first”, “second”, “third” and the like, whether used in the description or in the claims, are provided for distinguishing between similar elements and not necessarily for describing a sequential or chronological order. It is to be understood that the terms so used are interchangeable under appropriate circumstances (unless clearly disclosed otherwise) and that the embodiments of the disclosure described herein are capable of operation in other sequences and/or arrangements than are described or illustrated herein.

The terms “installed”, “provided with”, “sleeved/connected”, “connected”, etc., whether used in the description or in the claims, should be understood broadly. For example, “connected” can be a fixed connection, a detachable connection, or an integral connection, a mechanical connection, an electrical connection, a direct connection, or an indirect connection through an intermediate medium, and it can be a connection between two members. For those of ordinary skill in the art, the specific meaning of the above terms in the present disclosure can be understood under specific conditions. The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet sill cooperate or interact with each other).

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A power-generating apparatus, comprising:
a charge controller; and
an inverter, the inverter configured to:
receive a signal transmitted by the charge controller;
convert DC power to AC power; and
export 5-500 kW of AC power from the power-generating apparatus to a grid electrically coupled to the power-generating apparatus.

2. The power-generating apparatus of claim 1, wherein the inverter is a bidirectional inverter configured to:
receive AC power from a charge system connected to the power-generating apparatus; and
convert received AC power to DC power.

3. A system for aggregation and exportation of power to the grid, comprising:
a controller configured to:
monitor a grid stability of a grid and a cost of a unit of energy;
monitor a status of a plurality of nodes within a fleet, wherein the fleet comprises a combination of mobile and stationary resources; and
selectively receive and execute remote instructions from a user for transferring energy from at least one node of the plurality of nodes within the fleet to a grid.

4. The system of claim 3, the controller further configured to manage and monitor energy and value generation to the grid.

5. The system of claim 3, the system further comprising a bidirectional AC-DC-AC digital switching device.

6. The system of claim 5, wherein the bidirectional AC-DC-AC digital switching device is configured to:
convert DC power to AC power during energy transfer from at least one node of the plurality of nodes within the fleet;
monitor AC power voltage, frequency, and phase angle of the grid;
monitor power transferred from at least one vehicle of the plurality of vehicles within the fleet for compatibility with the AC power voltage, frequency, and phase angle of the grid; and
record to a memory the grid power quality and timing to facilitate generation of a compatible waveform.

7. The system of claim 5, wherein the bidirectional AC-DC-AC digital switching device is configured to facilitate charging of DC batteries of at least one node of the plurality of nodes within the fleet.

8. The system of claim 3, further comprising a communication system communicatively coupled with the controller and each node of the plurality of nodes within the fleet.

9. The system of claim 3, wherein the nodes include internal combustion generating units, hybrid combustion and electric units, battery electric units, or a combination thereof.

10. A method of using an interconnected system with a grid, the method comprising:
monitoring a connection status of one or more nodes within an interconnected system with a processor communicatively coupled to the one or more nodes;
detecting a triggering event with the processor, wherein the triggering event is at least one of: an emergency event, an insufficient grid power event, or an event in which a price of an energy unit meets or crosses a predetermined threshold;
receiving, with a charge controller of at least one node of the one or more nodes, a signal generated by the processor instructing the charge controller of the at least one node of the one or more nodes to transfer power from the at least one node of the one or more nodes to the grid; and
transferring power from the at least one node to the grid.

11. The method of claim 10, wherein the interconnected system is a closed system governed by a single entity.

12. The method of claim 10, wherein the grid is a microgrid configured to selectively provide power to a limited set of at least one of a consumer, a site, and an application.

13. The method of claim 10, wherein the one or more nodes includes a stationary resource and a mobile resource.

14. The method of claim 10, wherein the one or more nodes includes at least one internal-combustion engine.

15. The method of claim 10, further comprising receiving, with the charge controller of the at least one node of the one or more nodes, a signal generated by the processor instructing an increase in at least one of an amount and a rate of power transferred to the grid from the at least one node.

16. The method of claim 10, further comprising receiving, with a second charge controller of an additional node of the one or more nodes of the interconnected system, a signal generated by the processor instructing the second charge controller of the additional node of the one or more nodes to transfer power from the additional node of the one or more nodes to the grid.

17. The method of claim 10, further comprising receiving, with the charge controller of the at least one node of the one or more nodes, a signal generated by the processor instructing decrease in at least one of an amount and a rate of power transferred to the grid from the at least one node of the one or more nodes to the grid.

18. The method of claim 17, wherein the signal instructs cessation of power transfer from the at least one node of the one or more nodes to the grid.

19. The method of claim 10, wherein the step of receiving the signal instructing the charge controller of the at least one node of the one or more nodes to transfer power from the at least one node of the one or more nodes to the grid happens automatically upon detection of the triggering event.

20. The method of claim 10, wherein the step of monitoring the connection status of the one or more nodes includes receiving, with the processor, a signal from a telemetry unit of a respective node of the one or more nodes, wherein the telemetry unit is triggered to transmit the signal to the processor by:
receiving, with the telemetry unit, a signal from a respective charge controller of the respective node, the signal being transmitted from the respective charge controller upon connection of at least one of a charge system and a charger to a receiver of the respective node.
